(19) United States
(12) Patent Application Publication
(10) Pub. No.: US 2026/0259939 A1
(43) Pub. Date: Sep. 3, 2026

(54) METHOD AND SYSTEM FOR AUTOMATICALLY SUPPLEMENTING A DATA STREAM RECEIVED FROM A BUILDING MANAGEMENT SYSTEM TO AID IN SUBSEQUENT ACCESS, AGGREGATION, ANALYSIS AND DISPLAY OF DATA FROM THE DATA STREAM

(71) Applicant: Honeywell International Inc., Charlotte, NC (US)

(72) Inventors: WEILIN ZHANG, Beijing (CN); WEI QI, Beijing (CN)

(21) Appl. No.: 18/877,826

(22) PCT Filed: Jun. 22, 2022
(86) PCT No.: PCT/CN2022/100297

§ 371 Date: Dec. 20, 2024

(51) Int. Cl. G06F 16/907; G06F 3/0481; G06F 16/9038

(52) U.S. Cl. CPC G06F 16/907; G06F 3/0481; G06F 16/9038

(57) ABSTRACT

A data stream including a stream of point values are received from a BMS. One or more point tags that are based least in part on a point type of the respective point value are inserted into the data stream for each of one or more of the point values of the data stream, resulting in a supplemented data stream. The one or more point tags in the supplemented data stream are referenced to identify selected ones of the point values of the supplemented data stream. An aggregation tag is inserted into the supplemented data stream, wherein the aggregation tag includes an aggregation tag value that is an aggregation of the point values of the selected ones of the point values of the supplemented data stream. At least some of the supplemented data stream is displayed on a display including the aggregation tag value.

The present application claims priority to PCT International Application No. PCT/CN2022/100297, filed on Jun. 22, 2022, entitled “METHOD AND SYSTEM FOR AUTOMATICALLY SUPPLEMENTING A DATA STREAM RECEIVED FROM A BUILDING MANAGEMENT SYSTEM TO AID IN SUBSEQUENT ACCESS, AGGREGATION, ANALYSIS AND DISPLAY OF DATA FROM THE DATA STREAM”, which is incorporated herein by reference.

### TECHNICAL FIELD

The present disclosure relates to systems and methods for processing a data stream received from a building management system and more particularly to systems and methods for automatically supplementing a data stream received from a building management system to aid in subsequent access, aggregation, analysis and display of data from the data stream.

### BACKGROUND

With the migration of traditional building management systems (BMS) to the cloud, and the applications of big data analysis, traditional BMS systems are being challenged by customers. These challenges can include how to quickly build a big data streaming analysis that is based on the general requirements of BMS cloud applications, and how to efficiently normalize the data required by a big data engine from different subsystems. Most traditional BMS systems are deployed as a monolithic architecture on a single site, with each BMS system only serving one customer or one building, so that the data volume is small. The BMS cloud applications focus more on the analysis of data not only from building automation devices, but also from other enterprise application such as real-time alarm statistics, daily energy consumption, monthly energy consumption and real-time passenger flow statistics, etc., which needs to be aggregated in batch or by streaming.

An important part of big data analysis is how to model and normalize the data based on business requirements, i.e. the pre-processing of data. Since the data comes from different subsystems, they have different naming conventions, use different communication protocol and/or API's, etc. Therefore, it can be a challenge to design a flexible Extract/Transform/Load (ETL) tool for receiving data from heterogeneous sources and normalize them to meet BMS cloud application needs. What would be desirable would be systems and methods for processing a data stream received from a building management system, including automatically supplementing the data stream to aid in subsequent access and display of data from the data stream.

### SUMMARY

The disclosure pertains to systems and methods for processing a data stream received from a building management system and more particularly to systems and methods for automatically supplementing a data stream received from a building management system to aid in subsequent access and display of data from the data stream.

An example may be found in a method for supplementing a data stream received from a Building Management System (BMS). The illustrative method includes receiving the data stream from the BMS, wherein the data stream includes a stream of point values of each of a plurality of point types. At least some of the point values have a corresponding timestamp. One or more point tags are inserted into the data stream for each of one or more of the point values of the data stream. Each of the one or more point tags is based at least in part on the point type of the respective point value, resulting in a supplemented data stream. The one or more point tags in the supplemented data stream are referenced to identify selected ones of the point values of the supplemented data stream. An aggregation tag is inserted into the supplemented data stream, wherein the aggregation tag includes an aggregation tag value that is an aggregation of the point values of the selected ones of the point values of the supplemented data stream. At least some of the supplemented data stream is displayed on a display including the aggregation tag value.

Another example may be found in a method for supplementing a data stream received from a Building Management System (BMS) to aid in subsequent access and display of data from the data stream. The illustrative method includes receiving the data stream from the BMS. One or more data tags are inserted into the data stream resulting in a supplemented data stream. Each of the one or more data tags may be associated with a corresponding data element in the data stream. An output data stream is determined based at least in part on data elements of the supplemented data stream that share a common data tag. The output data stream may be displayed on a display.

Another example may be found in a system that includes an input for receiving a data stream from a BMS and a controller that is operatively coupled to the input. The controller is configured to insert one or more data tags into the data stream resulting in a supplemented data stream. Each of the one or more data tags is associated with a corresponding data element in the data stream. The controller is configured to determine an output data stream based at least in part on data elements of the supplemented data stream that share a common data tag, and to send the output data stream to a display for display.

The preceding summary is provided to facilitate an understanding of some of the features of the present disclosure and is not intended to be a full description. A full appreciation of the disclosure can be gained by taking the entire specification, claims, drawings, and abstract as a whole.

### BRIEF DESCRIPTION OF THE DRAWINGS

The disclosure may be more completely understood in consideration of the following description of various illustrative embodiments of the disclosure in connection with the accompanying drawings, in which:

FIG. 1 is a schematic block diagram of an illustrative system;

FIG. 2 is a flow diagram showing an illustrative method for supplementing a data stream received from a BMS system;

FIG. 3 is a flow diagram showing an illustrative method for supplementing a data stream received from a BMS system;

FIGS. 4A and 4B are flow diagrams that together show an illustrative method for supplementing a data stream received from a BMS system;

FIG. 5 is a flow diagram showing an illustrative method for supplementing a data stream received from a BMS system;

FIG. 6 is a flow diagram showing an illustrative method for supplementing a data stream received from a BMS system;

FIG. 7 is a schematic block diagram of an illustrative architecture;

FIG. 8 is a schematic block diagram of an illustrative implementation workflow; and

FIGS. 9 through 11 are screen shots showing an example of selected widgets used for displaying selected data from a supplemented data stream.

While the disclosure is amenable to various modifications and alternative forms, specifics thereof have been shown by way of example in the drawings and will be described in detail. It should be understood, however, that the intention is not to limit aspects of the disclosure to the particular illustrative embodiments described. On the contrary, the intention is to cover all modifications, equivalents, and alternatives falling within the spirit and scope of the disclosure.

### DESCRIPTION

The following description should be read with reference to the drawings wherein like reference numerals indicate like elements. The drawings, which are not necessarily to scale, are not intended to limit the scope of the disclosure. In some of the figures, elements not believed necessary to an understanding of relationships among illustrated components may have been omitted for clarity.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

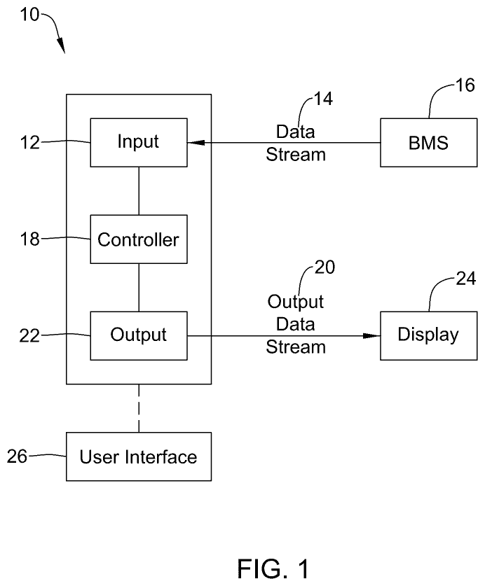

FIG. 1 is a schematic block diagram of an illustrative system 10. The illustrative system 10 includes an input 12 for receiving a data stream 14 from a BMS 16. A controller 18 is operably coupled with the input 12. The controller 18 is configured to insert one or more data tags into the data stream resulting in a supplemented data stream, each of the one or more data tags is associated with a corresponding data element in the data stream. The controller 18 is configured to determine an output data stream 20 based at least in part on data elements of the supplemented data stream that share a common data tag. The controller 18 is configured to send the output data stream 20 via an output 22 to a display 24 for display.

In some cases, the controller 18 may be configured to insert an aggregation tag into the supplemented data stream, wherein the aggregation tag includes an aggregation tag value that represents an aggregation of one or more data elements of the supplemented data stream that share the common data tag. In some cases, the output data stream 20 may include the aggregation tag. In some cases, the controller 18 may be configured to receive user input via a user interface 26, wherein the user input defines at least in part a widget including identifying the common data tag. The user interface 26 may be separate from the display 24. The display 24 may be part of the user interface 26, for example. In some cases, the widget references the common data tag and determines the output data stream 20 based at least in part on data elements of the supplemented data stream that share the common data tag.

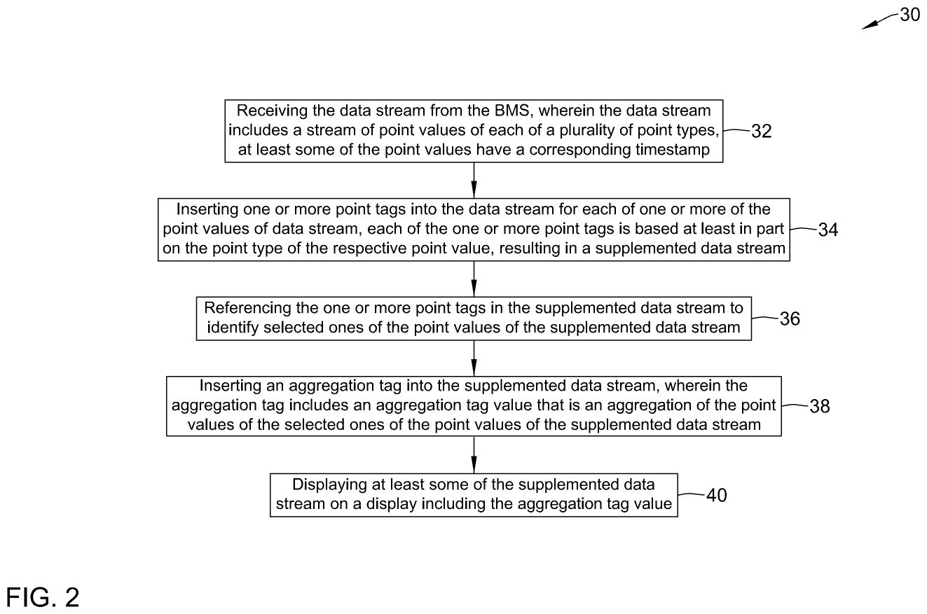

FIG. 2 is a flow diagram showing an illustrative method 30 for supplementing a data stream (such as the data stream 14) received from a Building Management System (BMS) (such as the BMS 16). The method 30 includes receiving the data stream from the BMS, wherein the data stream includes a stream of point values of each of a plurality of point types, at least some of the point values having a corresponding timestamp, as indicated at block 32.

In some cases, the data stream is a real-time. A real-time data stream need not be instantaneously delivered after the point values of the data stream are generated by the BMS. For example, a real-time data stream may include some delays, such as processing and communication delays, before being delivered to the system 10. It is contemplated that a real-time data stream may have delays of up to 15 minutes, up to 10 minutes, up to 5 minutes, up to 1 minute, up to 5 seconds, or less.

One or more point tags are inserted into the data stream for each of one or more of the point values of the data stream. Each of the one or more point tags is based at least in part on the point type of the respective point value, resulting in a supplemented data stream, as indicated at block 34. For example, a point type that corresponds to electricity consumption may be tagged with point tags such as {point role: “electricity”}, {interval: “900”}, {total} and {consumption}. These are just example point tags. In some cases, the method 30 includes inserting a plurality of point tags into the data stream for each of one or more of the point values of the data stream. Each of the plurality of point tags may be based at least in part on the point type of the respective point value, and in some cases a hierarchical level of the respective point value within the BMS (e.g. within a hierarchical model of the BMS).

The one or more point tags in the supplemented data stream are referenced to identify selected ones of the point values of the supplemented data stream, as indicated at block 36. An aggregation tag may be inserted into the supplemented data stream, wherein the aggregation tag includes an aggregation tag value that is an aggregation of the point values of the selected ones of the point values of the supplemented data stream, as indicated at block 38. In some cases, the aggregation tag value of the aggregation tag includes an aggregation of the point values of the selected ones of the point values of the supplemented data stream over a predetermined period of time. For example, the aggregation tag value of the aggregation tag may include an aggregation of the point values that are tagged with all of {point role: “electricity”}, {total} and {consumption} over a predetermined period of time as identified by a time stamp tag of the point values. In this example, the aggregation tag value may represent the total electricity consumption over the predetermined period of time. The aggregation tag with the aggregation tag value is then inserted into the supplemental data stream. In some cases, the aggregation tag value of the aggregation tag may include an aggregation of the point values of the selected ones of the point values of the supplemented data stream over a predetermined hierarchical level and/or over a plurality of predetermined hierarchical levels of the BMS.

In some cases, aggregation of the point values of the selected ones of the point values of the supplemented data stream may include a summation of the point values of the selected ones of the point values of the supplemented data stream over a predetermined period of time. Aggregation of the point values of the selected ones of the point values of the supplemented data stream may include, for example, a year-over-year difference of the point values of the selected ones of the point values of the supplemented data stream. In some cases, the aggregation of the point values of the selected ones of the point values of the supplemented data stream may include a sequential time period difference (e.g. month over month) of the point values of the selected ones of the point values of the supplemented data stream. The aggregation of the point values of the selected ones of the point values of the supplemented data stream may include an average, mean or standard deviation of the point values of the selected ones of the point values of the supplemented data stream over a predetermined period of time, for example.

At least some of the supplemented data stream is then displayed on a display including the aggregation tag value, as indicated at block 40. In some cases, the data stream is received from the BMS in real time, and the supplemental data stream is generated in real time. One or more of the point tags may include a group tag, wherein the group tag associates the respective point values that share the same group tag. In some cases, one or more of the point tags may include a topic tag, wherein the topic tag associates the respective point values of the data stream that share the same topic tag. Various different tags may be used to associated different groupings of point values, sometimes in a hierarchical manner.

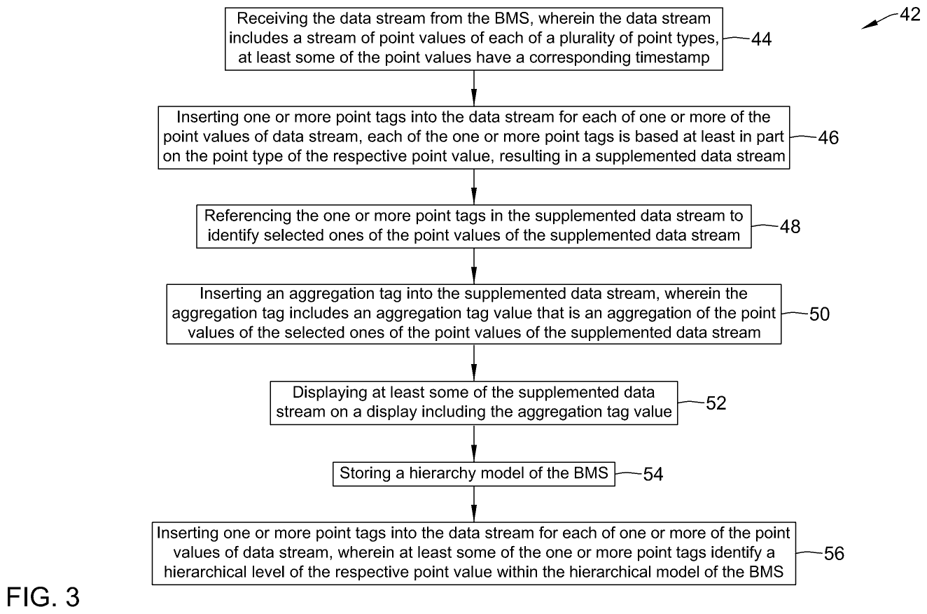

FIG. 3 is a flow diagram showing an illustrative method 42 for supplementing a data stream (such as the data stream 14) received from a Building Management System (BMS) (such as the BMS 16). The illustrative method 42 includes receiving the data stream from the BMS, wherein the data stream includes a stream of point values of each of a plurality of point types, at least some of the point values having a corresponding timestamp, as indicated at block 44. One or more point tags are inserted into the data stream for each of one or more of the point values of the data stream. Each of the one or more point tags may be based at least in part on the point type of the respective point value, resulting in a supplemented data stream, as indicated at block 46. In some cases, the method 42 includes inserting a plurality of point tags into the data stream for each of one or more of the point values of the data stream. Each of the plurality of point tags may be based at least in part on the point type of the respective point value and a hierarchical level of the respective point value within a hierarchy (e.g. hierarchical model) of the BMS.

The one or more point tags in the supplemented data stream are referenced to identify selected ones of the point values of the supplemented data stream, as indicated at block 48. An aggregation tag may be inserted into the supplemented data stream, wherein the aggregation tag includes an aggregation tag value that is an aggregation of the point values of the selected ones of the point values of the supplemented data stream, as indicated at block 50. In some cases, the aggregation tag value of the aggregation tag includes an aggregation of the point values of the selected ones of the point values of the supplemented data stream over a predetermined period of time. In some cases, the aggregation tag value of the aggregation tag may include an aggregation of the point values of the selected ones of the point values of the supplemented data stream over a predetermined hierarchical level and/or over a plurality of predetermined hierarchical levels of the BMS.

In some cases, aggregation of the point values of the selected ones of the point values of the supplemented data stream may include a summation of the point values of the selected ones of the point values of the supplemented data stream over a predetermined period of time. Aggregation of the point values of the selected ones of the point values of the supplemented data stream may include, for example, a year-over-year difference of the point values of the selected ones of the point values of the supplemented data stream. In some cases, the aggregation of the point values of the selected ones of the point values of the supplemented data stream may include a sequential time period difference (month to month) of the point values of the selected ones of the point values of the supplemented data stream. The aggregation of the point values of the selected ones of the point values of the supplemented data stream may include an average, mean or standard deviation of the point values of the selected ones of the point values of the supplemented data stream over a predetermined period of time, for example.

At least some of the supplemented data stream is displayed on a display, including the aggregation tag value, as indicated at block 52. In some cases, the data stream is received from the BMS in real time, and the supplemental data stream is generated in real time. One or more of the point tags may include a group tag, wherein the group tag associates the respective point values that share the same group tag. One or more of the point tags may include a topic tag, wherein the topic tag associates the respective point values of the data stream that share the same topic tag. Various different tags may be used to associated different groupings of point values, sometimes in a hierarchical manner.

In some cases, the method 42 may further include storing a hierarchy model of the BMS, as indicated at block 54. One or more point tags may be inserted into the data stream for each of one or more of the point values of the data stream, wherein at least some of the one or more point tags identify a hierarchical level of the respective point value within the hierarchical model of the BMS, as indicated at block 56.

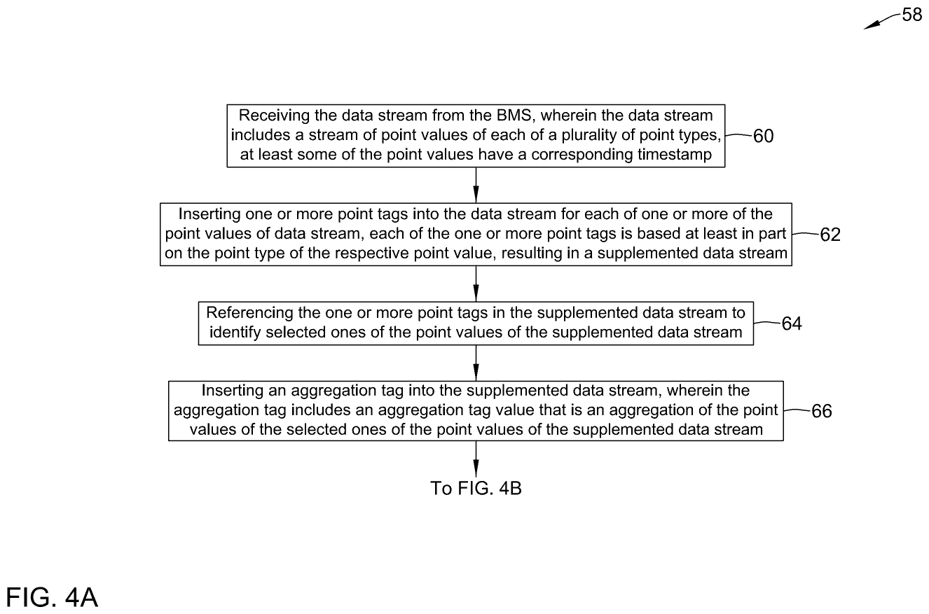

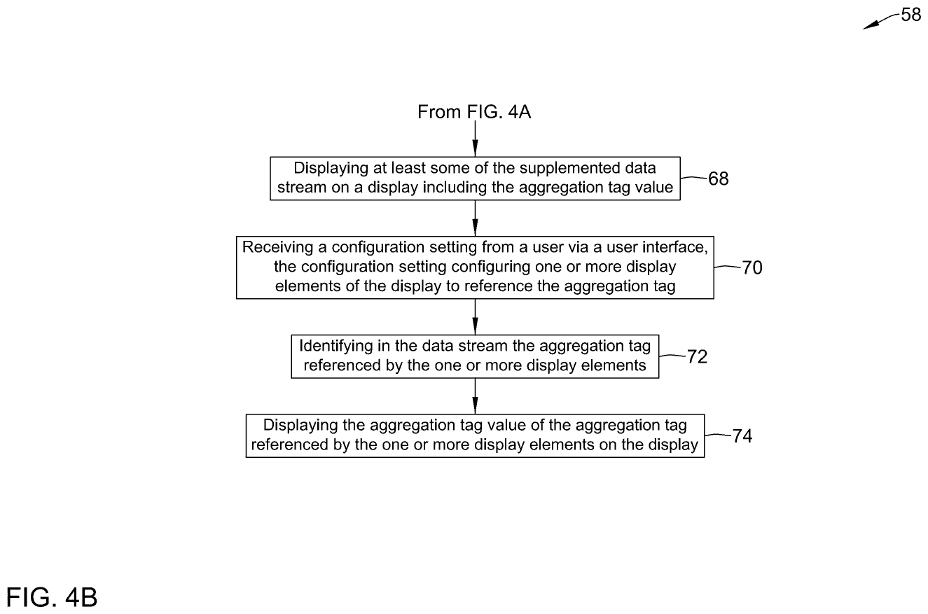

FIGS. 4A and 4B are flow diagrams that together show an illustrative method 58 for supplementing a data stream (such as the data stream 14) received from a Building Management System (BMS) (such as the BMS 16). The illustrative method 58 includes receiving the data stream from the BMS, wherein the data stream includes a stream of point values of each of a plurality of point types, at least some of the point values having a corresponding timestamp, as indicated at block 60. One or more point tags are inserted into the data stream for each of one or more of the point values of the data stream. Each of the one or more point tags may be based at least in part on the point type of the respective point value, resulting in a supplemented data stream, as indicated at block 62. In some cases, the method 58 includes inserting a plurality of point tags into the data stream for each of one or more of the point values of the data stream, wherein at least some of the plurality of point tags are based at least in part on the point type of the respective point value and a hierarchical level of the respective point value within a hierarchical model of the BMS.

The one or more point tags in the supplemented data stream are then referenced to identify selected ones of the point values of the supplemented data stream, as indicated at block 64. An aggregation tag is inserted into the supplemented data stream, wherein the aggregation tag includes an aggregation tag value that is an aggregation of the point values of the selected ones of the point values of the supplemented data stream, as indicated at block 66. In some cases, the aggregation tag value of the aggregation tag includes an aggregation of the point values of the selected ones of the point values of the supplemented data stream over a predetermined period of time. In some cases, the aggregation tag value of the aggregation tag may include an aggregation of the point values of the selected ones of the point values of the supplemented data stream over a predetermined hierarchical level and/or over a plurality of predetermined hierarchical levels of the BMS.

In some cases, aggregation of the point values of the selected ones of the point values of the supplemented data stream may include a summation of the point values of the selected ones of the point values of the supplemented data stream over a predetermined period of time. Aggregation of the point values of the selected ones of the point values of the supplemented data stream may include, for example, a year-over-year difference of the point values of the selected ones of the point values of the supplemented data stream. In some cases, the aggregation of the point values of the selected ones of the point values of the supplemented data stream may include a sequential time period difference (e.g. month to month) of the point values of the selected ones of the point values of the supplemented data stream. The aggregation of the point values of the selected ones of the point values of the supplemented data stream may include an average, mean or standard deviation of the point values of the selected ones of the point values of the supplemented data stream over a predetermined period of time, for example.

The method 58 continues on FIG. 4B with at least some of the supplemented data stream is displayed on a display including the aggregation tag value, as indicated at block 68. In some cases, the data stream is received from the BMS in real time, and the supplemented data stream is implemented in real time. One or more of the point tags may include a group tag, wherein the group tag associates the respective point values that share the same group tag. One or more of the point tags may include a topic tag, wherein the topic tag associates the respective point values of the data stream that share the same topic tag. Various different tags may be used to associated different groupings of point values, sometimes in a hierarchical manner.

The method 58 may further include receiving a configuration setting from a user via a user interface. The configuration setting configures one or more display elements (e.g. widgets) of the display to reference the aggregation tag, as indicated at block 70. The aggregation tag referenced by the one or more display elements is then identified in the supplemental data stream, as indicated at block 72. In some cases, the method 58 may include displaying the aggregation tag value of the aggregation tag referenced by the one or more display elements on the display, as indicated at block 74.

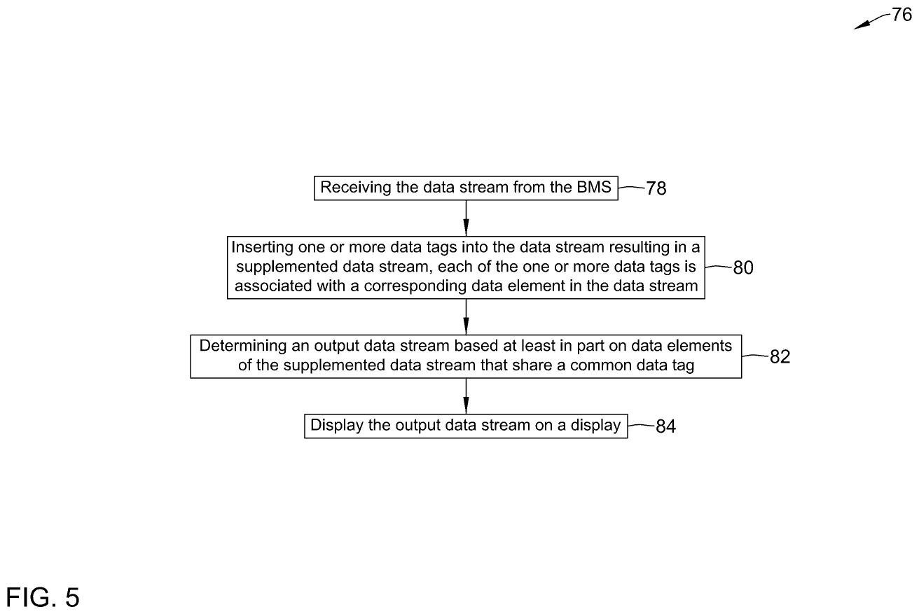

FIG. 5 is a flow diagram showing an illustrative method 76 for supplementing a data stream (such as the data stream 14) received from a Building Management System (BMS) (such as the BMS 16) to aid in subsequent access and display of data from the data stream. The method 76 includes receiving the data stream from the BMS, as indicated at block 78. One or more data tags are inserted into the data stream resulting in a supplemented data stream, each of the one or more data tags is associated with a corresponding data element in the data stream, as indicated at block 80. An output data stream is determined based at least in part on data elements of the supplemented data stream that share a common data tag, as indicated at block 82. The output data stream is displayed on a display, as indicated at block 84. In some cases, determining the output data stream includes inserting an aggregation tag into the supplemented data stream, wherein the aggregation tag includes an aggregation tag value that represents an aggregation of one or more data elements of the supplemented data stream that share the common data tag. In some cases, the output data stream includes the aggregation tag.

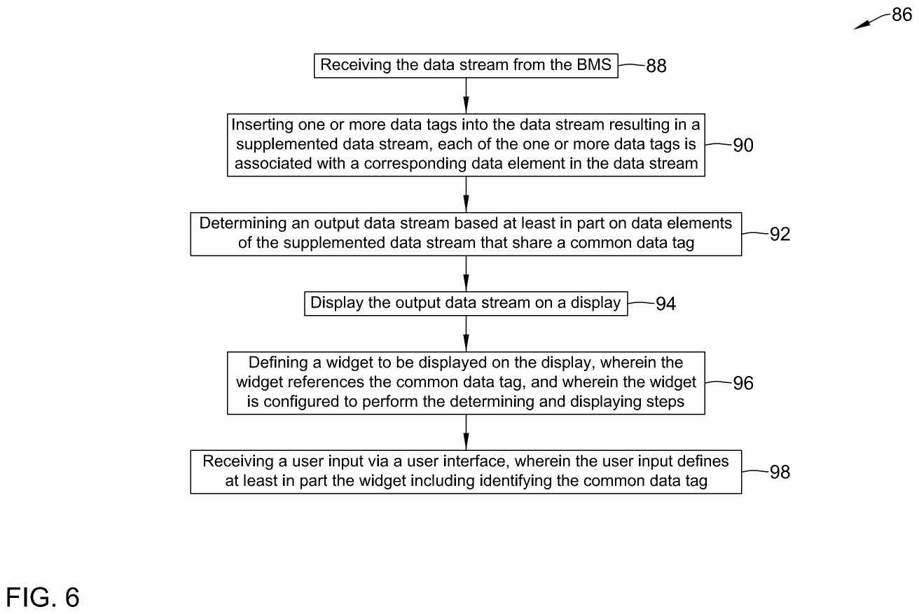

FIG. 6 is a flow diagram showing an illustrative method 86 for supplementing a data stream (such as the data stream 14) received from a Building Management System (BMS) (such as the BMS 16) to aid in subsequent access and display of data from the data stream. The method 86 includes receiving the data stream from the BMS, as indicated at block 88. One or more data tags are inserted into the data stream resulting in a supplemented data stream, each of the one or more data tags is associated with a corresponding data element in the data stream, as indicated at block 90. An output data stream is determined based at least in part on data elements of the supplemented data stream that share one or more common data tags, as indicated at block 92. The output data stream is displayed on a display, as indicated at block 94. In some cases, determining the output data stream includes inserting an aggregation tag into the supplemented data stream, wherein the aggregation tag includes an aggregation tag value that represents an aggregation of one or more data elements of the supplemented data stream that share one or more common data tags. In some cases, the output data stream includes the aggregation tag.

In some cases, the method 86 may further include defining a widget to be displayed on the display, wherein the widget references the one or more common data tags, and wherein the widget is configured to determining the output data stream and displaying the output data stream, as indicated at block 96. In some cases, the method 86 may further include receiving a user input via a user interface, wherein the user input defines at least in part the widget including identifying the one or more common data tags, as indicated at block 98.

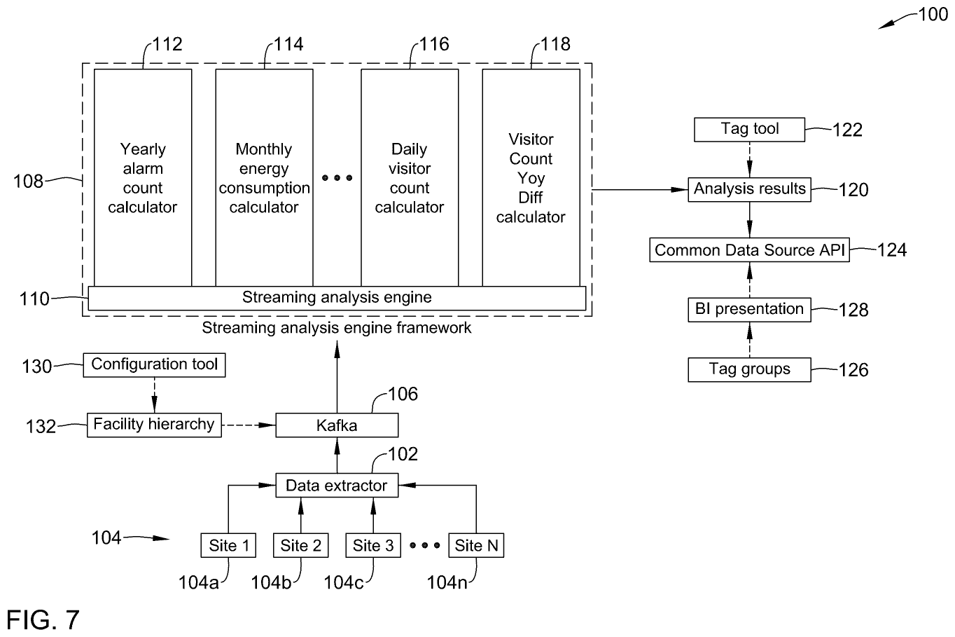

FIG. 7 is a schematic block diagram of an illustrative architecture 100. The illustrative architecture 100 includes a data extractor 102 that is configured to extract data from a number of BMS sites 104, individually labeled as 104a, 104b, 104c and through 104n. The data extractor 102 may extract data from any number of different sites. In some cases, the data extractor 102 inserts one or more point tags into the data streams extracted from the BMS sites 104 to produce a supplemental data stream. The point tags may be based at least in part on the point types of the respective points. The data extractor 102 may also insert tags that indicate the hierarchy of the points in the overall hierarchy of the BMS system (which in this example includes various BMS sites 104). The tags to be inserted may be defined by the Facility hierarch block 132, which can be configured using a configuration tool 130. The data extractor 102 puts the resulting supplemental data stream into Kafka (an open-source distributed event streaming platform) 106 streams of topics, which are then provided to a streaming analysis engine framework 108.

The supplemental data stream with the inserted tags is provided to the streaming analysis engine framework 108, which includes a streaming analysis engine 110. The streaming analysis engine 110 may include one or more calculators, such as but not limited to a yearly alarm count calculator 112, a monthly energy consumption calculator 114, a daily visitor count calculator 116 and a visitor count YOY (year over year) calculator 118. These are just examples. It is contemplated that the streaming analysis engine 110 may include a variety of different calculators, depending on the desired application.

The streaming analysis engine framework 108 references the tags in the supplemental data stream provided by Kafka 106 to identify appropriate point values in the supplemental data stream for processing by each of the various calculators 112, 114, 116 and 118. Each of the calculators 112, 114, 116 and 118 may calculate an aggregation of one or more point values of the supplemented data stream provided by Kafka 106 that share one or more corresponding common data tags. Each of the calculators 112, 114, 116 and 118 may insert a corresponding aggregation tag into the supplemented data stream, wherein the aggregation tag includes the calculated aggregation tag value. The streaming analysis engine framework 108 outputs the resulting supplemented data stream to an analysis results block 120. A tag tool 122 provides tags that may have been used in the supplemented data stream for reference. The results flow to a Common data source API 124. In some cases, a Tag groups block 126 provides available tags to a Business Intelligence (BI) presentation block 128.

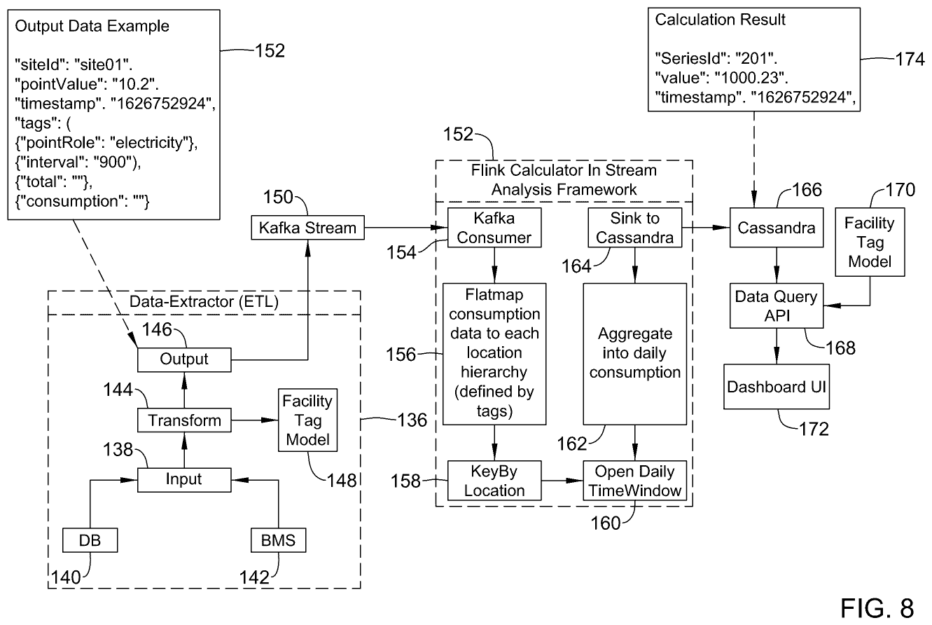

FIG. 8 is a schematic block diagram of an illustrative implementation workflow 134. The illustrative implementation workflow 134 includes a data extractor block 136, which may be considered as being an example of the data extractor 102. The data extractor block 136 includes an input 138, which receives information from a database 140 and a BMS 142. A transform block 144 outputs to an output 146 as well as a facility tag model 148. The data extractor block 136 collectively outputs to a Kafka stream block 150. An example of the data output is seen at 152. In this embodiment, the data extractor block 136 has added tags to the data stream. For example, a point type that corresponds to electricity consumption has been tagged with point tags {point role: “electricity”}, {interval: “900”}, {total} and {consumption}. These are just example point tags. The data extractor block 136 may also normalize the point values to a common format, and in some cases remove and/or correct outlier and/or missing data.

In the example workflow, the Kafka stream block 150 communicates with a Flink calculator 152, which includes a Kafka consumer 154. The consumed data is mapped to each location via the inserted tags, as indicated at block 156. For example, data is keyed by location tags, as indicated at block 158. Daily consumption is determined at block 160, and is aggregated into total daily consumption at block 162. The data is output, as indicated at block 164, to Cassandra 166. Cassandra 166 reports to a data query block 168, as does a facility tag model 170. The data query block 168 outputs to a dashboard 172. An example of calculation results is shown at 174.

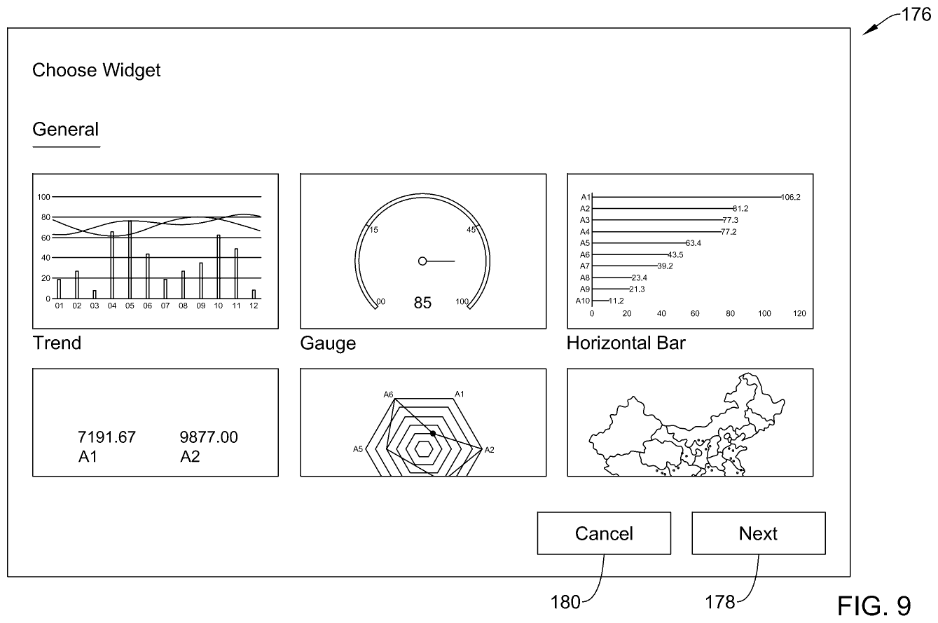

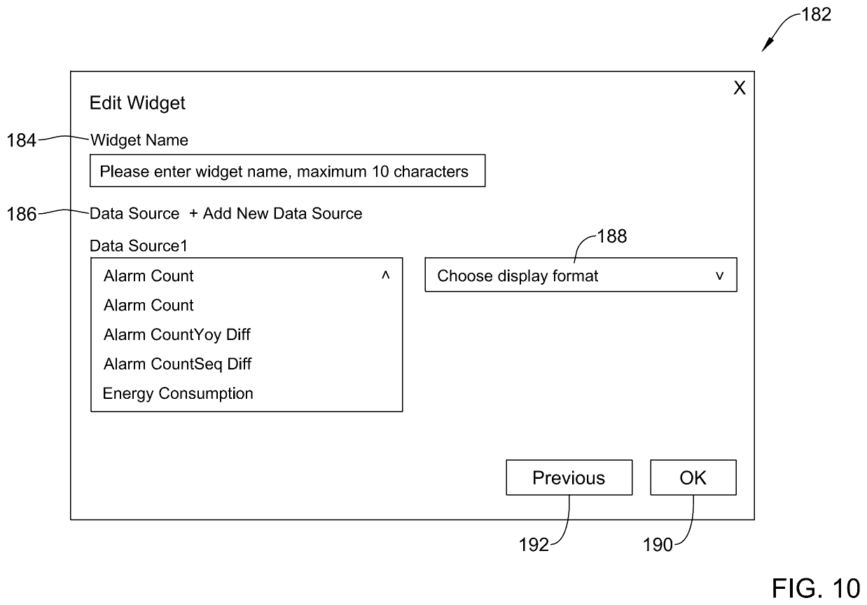

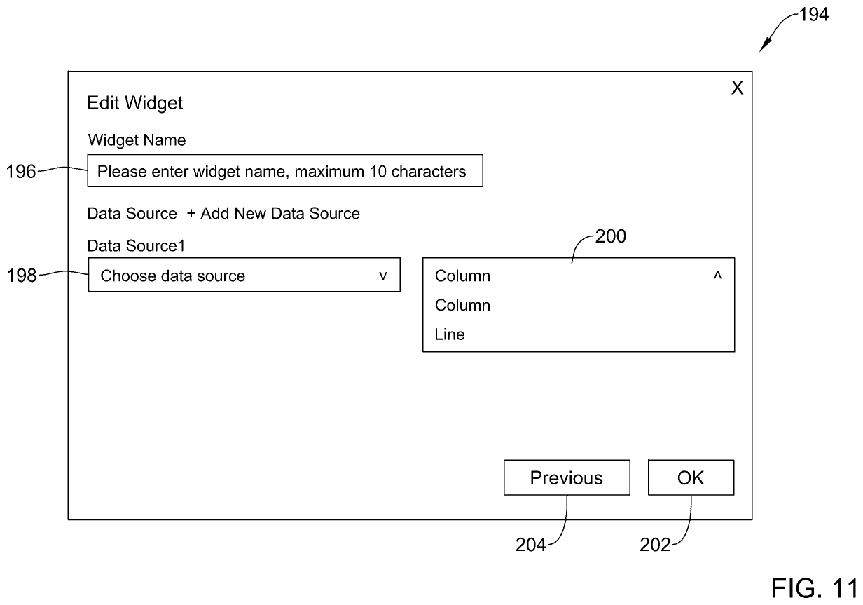

In some cases, display elements such as widgets may be used to define all or parts of a dashboard. Step One is to choose the location of one or more widgets on the dashboard. Step Two, as shown for example in FIG. 9, includes choosing a widget from a plurality of widget types. FIG. 9 shows a screen 176 that includes a number of widget types, such as but not limited to trend, gauge, horizontal bar, and others. The screen 176 includes a Next button 178 that may be used to select one or more chosen widget types, and a Cancel button 180 that may be selected to cancel out. Step Three, as shown for example in FIG. 10, includes selecting tags as data source for a selected widget. FIG. 10 shows a screen 182 that includes a widget name entry 184, a data source entry 186 and a display format entry 188. The data source entry 186 may list one or more tags that have been added to the supplemental data stream. The screen 182 includes an OK button 190 that may be selected to accept the entered information and a Previous button 192 that may be selected to return to a previous screen (such as the screen 176 shown in FIG. 9). Step Four, as shown for example in FIG. 11, is to choose the widget style. FIG. 11 shows a screen 194 that includes a widget name entry 196, a data source entry 198 and a widget style entry 200. The screen 194 includes an OK button 202 that may be selected to accept the entered information and a Previous button 204 that may be selected to return to a previous screen (such as the screen 182 shown in FIG. 10).

Those skilled in the art will recognize that the present disclosure may be manifested in a variety of forms other than the specific embodiments described and contemplated herein. Accordingly, departure in form and detail may be made without departing from the scope and spirit of the present disclosure as described in the appended claims.

What is claimed is:

1. A method for supplementing a data stream received from a Building Management System (BMS), the method comprising:
receiving the data stream from the BMS, wherein the data stream includes a stream of point values of each of a plurality of point types, at least some of the point values having a corresponding timestamp;
inserting one or more point tags into the data stream for each of one or more of the point values of the data stream, each of the one or more point tags is based at least in part on the point type of the respective point value, resulting in a supplemented data stream;
referencing the one or more point tags in the supplemented data stream to identify selected ones of the point values of the supplemented data stream;
inserting an aggregation tag into the supplemented data stream, wherein the aggregation tag includes an aggregation tag value that is an aggregation of the point values of the selected ones of the point values of the supplemented data stream; and
displaying at least some of the supplemented data stream on a display including the aggregation tag value.

2. The method of claim 1, wherein the data stream is received from the BMS in real time, and the inserting, referencing, inserting and displaying steps are implemented in real time.

3. The method of claim 1, further comprising:
storing a hierarchy model of the BMS; and
inserting one or more point tags into the data stream for each of one or more of the point values of the data stream, wherein at least some of the one or more point tags identify a hierarchical level of the respective point value within the hierarchical model of the BMS.

4. The method of claim 1, comprising:
inserting a plurality of point tags into the data stream for each of one or more of the point values of the data stream, each of the plurality of point tags is based at least in part on the point type of the respective point value and a hierarchical level of the respective point value within a hierarchical model of the BMS.

5. The method of claim 1, wherein the aggregation tag value of the aggregation tag comprises an aggregation of the point values of the selected ones of the point values of the supplemented data stream over a predetermined period of time.

6. The method of claim 1, wherein the aggregation tag value of the aggregation tag comprises an aggregation of the point values of the selected ones of the point values of the supplemented data stream over a predetermined hierarchical level and/or over a plurality of predetermined hierarchical levels of the BMS.

7. The method of claim 1, wherein the aggregation of the point values of the selected ones of the point values of the supplemented data stream comprises a summation of the point values of the selected ones of the point values of the supplemented data stream over a predetermined period of time.

8. The method of claim 1, wherein the aggregation of the point values of the selected ones of the point values of the supplemented data stream comprises a year-over-year difference of the point values of the selected ones of the point values of the supplemented data stream.

9. The method of claim 1, wherein the aggregation of the point values of the selected ones of the point values of the supplemented data stream comprises a sequential time period difference of the point values of the selected ones of the point values of the supplemented data stream.

10. The method of claim 1, wherein the aggregation of the point values of the selected ones of the point values of the supplemented data stream comprises an average, mean or standard deviation of the point values of the selected ones of the point values of the supplemented data stream over a predetermined period of time.

11. The method of claim 1, wherein one or more of the point tags comprises a group tag, wherein the group tag associates the respective point values that share the same group tag.

12. The method of claim 1, wherein one or more of the point tags comprises a topic tag, wherein the topic tag associates the respective point values of the data stream that share the same topic tag.

13. The method of claim 1, further comprising:
receiving a configuration setting from a user via a user interface, the configuration setting configuring one or more display elements of the display to reference the aggregation tag;
identifying in the data stream the aggregation tag referenced by the one or more display elements; and
displaying the aggregation tag value of the aggregation tag referenced by the one or more display elements on the display.

14. A method for supplementing a data stream received from a Building Management System (BMS) to aid in subsequent access and display of data from the data stream, the method comprising:
receiving the data stream from the BMS;
inserting one or more data tags into the data stream resulting in a supplemented data stream, each of the one or more data tags is associated with a corresponding data element in the data stream;
determining an output data stream based at least in part on data elements of the supplemented data stream that share a common data tag; and
display the output data stream on a display.

15. The method of claim 14, wherein determining the output data stream comprises:
inserting an aggregation tag into the supplemented data stream, wherein the aggregation tag includes an aggregation tag value that represents an aggregation of one or more data elements of the supplemented data stream that share the common data tag; and
wherein the output data stream includes the aggregation tag.

16. The method of claim 14, further comprising:
defining a widget to be displayed on the display, wherein the widget references the common data tag, and wherein the widget is configured to perform the determining and displaying steps.

17. The method of claim 16, further comprising:
receiving a user input via a user interface, wherein the user input defines at least in part the widget including identifying the common data tag.

18. A system, comprising:
an input for receiving a data stream from a BMS;
a controller operatively coupled to the input, the controller configured to:
insert one or more data tags into the data stream resulting in a supplemented data stream, each of the one or more data tags is associated with a corresponding data element in the data stream;
determine an output data stream based at least in part on data elements of the supplemented data stream that share a common data tag; and
send the output data stream to a display for display.

19. The system of claim 18, wherein the controller is configured to:
insert an aggregation tag into the supplemented data stream, wherein the aggregation tag includes an aggregation tag value that represents an aggregation of one or more data elements of the supplemented data stream that share the common data tag; and
wherein the output data stream includes the aggregation tag.

20. The system of claim 18, wherein the controller is configured to:
receive user input via a user interface, wherein the user input defines at least in part a widget including identifying the common data tag; and
wherein the widget references the common data tag and determines the output data stream based at least in part on data elements of the supplemented data stream that share the common data tag.
